(19) United States
(12) Patent Application Publication
(10) Pub. No.: US 2025/0128164 A1
(43) Pub. Date: Apr. 24, 2025

(54) SYSTEM FOR RENDERING SKIN TONE WITHIN A GAME APPLICATION ENVIRONMENT

(71) Applicant: Electronic Arts Inc., Redwood City, CA (US)

(72) Inventor: Joanna Brette Erbach, Edmonton (CA)

(21) Appl. No.: 18/491,497

(22) Filed: Oct. 20, 2023

(51) Int. Cl. A63F 13/60

(52) U.S. Cl. CPC A63F 13/60; A63F 2300/538; A63F 2300/8082

(57) ABSTRACT

The present disclosure provides a system for rendering skin tones of virtual entities using dynamic lighting systems within the virtual environment. The dynamic lighting system can be used to modify parameters of light sources within a game environment to increase the range of renderable skin tones of a virtual entity.

### BACKGROUND

Video games are becoming increasingly more complex and realistic. In order to create more realistic environments, games are including virtual characters that appear more and more lifelike. With increased realism of video games, there is a desire for broader representations of characters within the virtual environments of game applications.

### SUMMARY OF EMBODIMENTS

The systems, methods, and devices of this disclosure each have several innovative aspects, no single one of which is solely responsible for all of the desirable attributes disclosed herein.

In some aspects, the techniques described herein relate to a computer-implemented method for generating visual content within a game application, including: by a hardware processor configured with computer executable instructions, executing a game application including a virtual environment, the virtual environment including a plurality of virtual entities; determining simulation data associated with runtime of the game application based at least in part on gameplay information associated with a gameplay state of the game application; identifying a first virtual entity based at least in part on the simulation data within a game scene, wherein the first virtual entity is associated with a first dynamic lighting characteristic; identifying a first dynamic light source associated with the game scene; modifying at least one parameter of the first dynamic light source based at least in part on the first dynamic lighting characteristic, wherein the modification of the at least one parameter changes light incident on the first virtual entity within the game scene; and rendering the at least one virtual entity within the game scene based at least in part on the first dynamic light source.

In some aspects, the techniques described herein relate to a computer-implemented method, wherein the at least one parameter of the dynamic light source is a light intensity.

In some aspects, the techniques described herein relate to a computer-implemented method, wherein the game scene includes a second virtual entity is associated with a second dynamic lighting characteristic.

In some aspects, the techniques described herein relate to a computer-implemented method, wherein the first virtual entity is associated with a first priority value and the second virtual entity is associated with a first priority value, wherein the method includes determining that the first priority value is greater than the second priority value and modifying the at least one parameter of the first dynamic light source based on the first dynamic lighting characteristic.

In some aspects, the techniques described herein relate to a computer-implemented method, further including modifying at least one parameter of a second dynamic light source based at least in part on the second dynamic lighting characteristic.

In some aspects, the techniques described herein relate to a computer-implemented method, wherein the first dynamic light source is one of a plurality of light sources within the game scene and at least one light source of the plurality of light sources is not modified by the first dynamic lighting characteristic.

In some aspects, the techniques described herein relate to a computer-implemented method, wherein the first dynamic characteristic is determined based on a skin coloring of a skin texture of the first virtual entity.

In some aspects, the techniques described herein relate to a computer-implemented method, wherein rendering the at least one virtual entity within the game scene is based at least in part on the light incident on the skin texture of the first virtual entity within the game scene.

In some aspects, the techniques described herein relate to a computer-implemented method, wherein rendering the at least one virtual entity within the game scene is based at least in part on a smoothness characteristic, subsurface scattering, and a melanin mask associated with the skin texture of the first virtual entity, wherein the smoothness characteristic, the subsurface scattering, and the melanin mask are determined based on the skin coloring of the first virtual entity.

In some aspects, the techniques described herein relate to non-transitory computer-readable medium storing computer-executable instructions that when executed by one or more processors, cause the one or more processors to perform operations including, including: executing a game application including a virtual environment, the virtual environment including a plurality of virtual entities; determining simulation data associated with runtime of the game application based at least in part on gameplay information associated with a gameplay state of the game application; identifying a first virtual entity based at least in part on the simulation data within a game scene, wherein the first virtual entity is associated with a first dynamic lighting characteristic; identifying a first dynamic light source associated with the game scene; modifying at least one parameter of the first dynamic light source based at least in part on the first dynamic lighting characteristic, wherein the modification of the at least one parameter changes light incident on the first virtual entity within the game scene; and rendering the at least one virtual entity within the game scene based at least in part on the first dynamic light source.

In some aspects, the techniques described herein relate to a non-transitory computer-readable medium, wherein the at least one parameter of the dynamic light source is a light intensity.

In some aspects, the techniques described herein relate to a non-transitory computer-readable medium, wherein the game scene includes a second virtual entity is associated with a second dynamic lighting characteristic.

In some aspects, the techniques described herein relate to a non-transitory computer-readable medium, wherein the first virtual entity is associated with a first priority value and the second virtual entity is associated with a first priority value, wherein the instructions further configure the one or more processors to perform operations including determining that the first priority value is greater than the second priority value and modifying the at least one parameter of the first dynamic light source based on the first dynamic lighting characteristic.

In some aspects, the techniques described herein relate to a non-transitory computer-readable medium, wherein the instructions further configure the one or more processors to perform operations including modifying at least one parameter of a second dynamic light source based at least in part on the second dynamic lighting characteristic.

In some aspects, the techniques described herein relate to a non-transitory computer-readable medium, wherein the first dynamic light source is one of a plurality of light sources within the game scene and at least one light source of the plurality of light sources is not modified by the first dynamic lighting characteristic.

In some aspects, the techniques described herein relate to a non-transitory computer-readable medium, wherein the first dynamic characteristic is determined based on a skin coloring of a skin texture of the first virtual entity.

In some aspects, the techniques described herein relate to a non-transitory computer-readable medium, wherein rendering the at least one virtual entity within the game scene is based at least in part on the light incident on the skin texture of the first virtual entity within the game scene.

In some aspects, the techniques described herein relate to a non-transitory computer-readable medium, wherein rendering the at least one virtual entity within the game scene is based at least in part on a smoothness characteristic, subsurface scattering, and a melanin mask associated with the skin texture of the first virtual entity, wherein the smoothness characteristic, the subsurface scattering, and the melanin mask are determined based on the skin coloring of the first virtual entity.

In some aspects, the techniques described herein relate to a system including one or more processors and non-transitory computer storage medium storing instructions that when executed by the one or more processors, cause the one or more processors to perform operations including: executing a game application including a virtual environment, the virtual environment including a plurality of virtual entities; determining simulation data associated with runtime of the game application based at least in part on gameplay information associated with a gameplay state of the game application; identifying a first virtual entity based at least in part on the simulation data within a game scene, wherein the first virtual entity is associated with a first dynamic lighting characteristic; identifying a first dynamic light source associated with the game scene; modifying at least one parameter of the first dynamic light source based at least in part on the first dynamic lighting characteristic, wherein the modification of the at least one parameter changes light incident on the first virtual entity within the game scene; and rendering the at least one virtual entity within the game scene based at least in part on the first dynamic light source.

In some aspects, the techniques described herein relate to a system, wherein the first dynamic light source is one of a plurality of light sources within the game scene and at least one light source of the plurality of light sources is not modified by the first dynamic lighting characteristic.

### BRIEF DESCRIPTION OF THE DRAWINGS

Throughout the drawings, reference numbers are re-used to indicate correspondence between referenced elements. The drawings are provided to illustrate embodiments of the subject matter described herein and not to limit the scope thereof.

FIG. 1 illustrates an embodiment of a computing system that can implement one or more embodiments of a visual content generation system.

FIG. 2 illustrates an example embodiment of a control system associated with a skin tone analysis of a virtual object within a game application.

FIG. 3 illustrates one embodiment of a block diagram illustrating a data flow for generation of visual content for a game application.

FIG. 4 illustrates embodiments of visual content generated for a game application.

FIG. 5 illustrates an embodiment of a range of skin tones and hues.

FIGS. 6A and 6B illustrates a flowchart of an embodiment of a content streaming process.

FIG. 7 illustrates a flowchart of an embodiment of a skin tone analysis process.

FIG. 8 illustrates a flowchart of an embodiment of a visual content generation process.

FIG. 9 illustrates an embodiment of a computing device.

### DETAILED DESCRIPTION OF EMBODIMENTS

### Overview

As graphics quality increases, the games become more complex and more detailed, each processing and rendering system can require complex processes to provide a high quality experience for all aspects of the rendering processes. One of the problems encountered in video games is generating and rendering a broad range of skin tones during runtime of a game application. It can be difficult to properly render darker skin tones within a game environment. This can result in a reduced range of skin tones that are available for use on virtual entities within a video game. However, it is important to provide diverse and representative skin tones for virtual entities within a game application. This can further allow for game developers to create immersive, engaging, and representative game worlds.

The present disclosure provides a system for rendering skin tones of virtual entities using dynamic lighting systems within the virtual environment. The dynamic lighting system can be used to modify parameters of light sources within a game environment to increase the range of renderable skin tones of a virtual entity. The dynamic lighting system may use a dynamic lighting characteristic associated with a virtual character within a game scene. The dynamic lighting characteristic can be determined based on skin characteristic of the virtual entity. For example, the dynamic lighting characteristic may be based on the skin characteristic, such as, tone, hue, smoothness, subsurface scattering, and/or melanin mask associated with the virtual entity. The dynamic lighting characteristic can be generated when a virtual entity is created based on the skin characteristic. The dynamic lighting characteristic can be a set value that is assigned to a virtual entity during creation. If the skin tone of a virtual entity changes during the game, the dynamic lighting characteristic can be determined based on the change to the skin tone. The dynamic lighting characteristic can be configured to cause a relative adjustment of a light intensity of a dynamic light source. For example, the dynamic lighting characteristic may be set at a value that causes the light intensity of the light source to increase by 50%, in another dynamic lighting characteristic may cause the light source to decrease by 20%.

The dynamic lighting characteristic can be communicated to the dynamic lighting system during runtime rendering of the game application. The dynamic lighting characteristic associated with a virtual entity can be passed to the dynamic lighting system to adjust the lighting for rendering. The rendering engine can receive scene data associated with the game state, such as simulation data, adjusted lighting data, and function data. The rendering engine can use the scene data to determine rendering characteristics associated with the skin tone of the virtual entity within the frame. The rendering engine can generate rendering parameters that determine how the virtual entity is to be rendered within the game scene, and render a frame.

Although certain embodiments and examples are disclosed herein, inventive subject matter extends beyond the examples in the specifically disclosed embodiments to other alternative embodiments and/or uses, and to modifications and equivalents thereof. For example, the systems used herein can extend beyond the use of skin textures and can apply to other textures within the virtual environment, such as hair or clothing.

### Overview of Video Game Environment

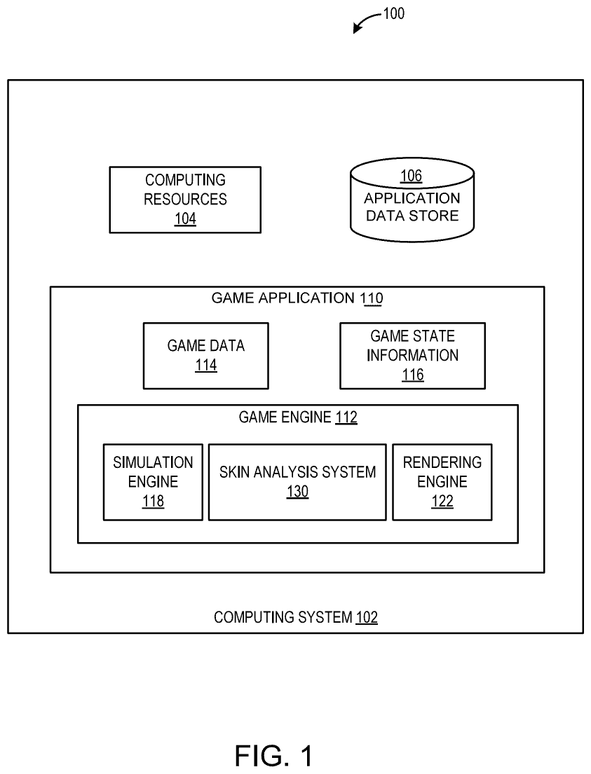

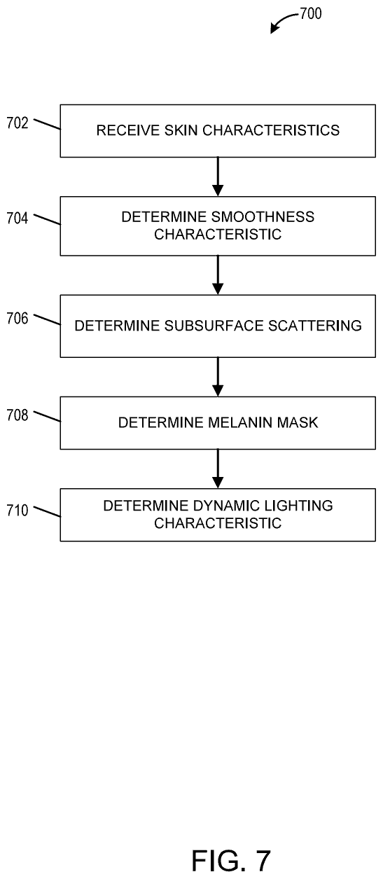

FIG. 1 illustrates an embodiment of a computing system 100 for executing a game application 110 on a user computing system 102. The user computing system 102 includes computing resources 104, an application data store 106, and a game application 110. The user computing system 102 may have varied local computing resources 104 such as central processing units and architectures, memory, mass storage, graphics processing units, communication network availability and bandwidth, and so forth. Further, the user computing system 102 may include any type of computing system. For example, the user computing system 102 may be any type of computing device, such as a desktop, laptop, video game platform/console, television set-top box, television (for example, Internet TVs), network-enabled kiosk, car-console device, computerized appliance, wearable device (for example, smart watches and glasses with computing functionality), and wireless mobile devices (for example, smart phones, personal digital assistants, tablets, or the like), to name a few. A more detailed description of an embodiment of user computing system 102 is described below with respect to FIG. 7.

### Game Application

In one embodiment, the user computing system 102 can execute a game application 110 based on software code stored at least in part in the application data store 106. The game application 110 may also be referred to as a videogame, a game, game code, and/or a game program. A game application 110 should be understood to include software code that a user computing system 102 can use to provide a game for a user to play. A game application 110 may comprise software code that informs a user computing system 102 of processor instructions to execute, but may also include data used in the playing of the game, such as data relating to constants, images and other data structures. For example, in the illustrated embodiment, the game application 110 includes game data 114, game state information 116, and a game engine 112, which includes a simulation engine 118, a mesh particle engine 120, and a rendering engine 122.

In some embodiments, the user computing system 102 is capable of executing a game application 110, which may be stored and/or executed in a distributed environment. For example, the user computing system 102 may execute a portion of a game and a network-based computing system (not shown), may execute another portion of the game. For instance, the game may be an online car racing game that includes a client portion executed by the user computing system 102 and a server portion executed by one or more application host systems.

### Game Engine

In one embodiment, the game engine 112 is configured to execute aspects of the operation of the game application 110 within the computing device 100. Execution of aspects of gameplay within a game application can be performed by the simulation engine 118, the skin analysis system, and the rendering engine 122. The runtime execution of the game application can be based, at least in part, on the user input received, the game data 114, and/or the game state information 116. The game data 114 can include game rules, prerecorded motion capture poses/paths, environmental settings, constraints, skeleton models, and/or other game application information.

### Simulation Engine

The simulation engine 118 can read in game rules and generates game state based on input received from one or more users. The simulation engine 118 can control execution of individual objects, such as virtual components, virtual effects and/or virtual characters, within the game application. The simulation engine 118 can manage and determine character movement, character states, collision detection, derive desired motions for characters and virtual objects (such as, cars) based gameplay information. The simulation engine 118 receives gameplay information, such as user inputs, and determines virtual entity events, such as actions, collisions, runs, driving direction, velocity, attacks and other events appropriate for the game. The virtual entity events can be controlled by movement rules that determine the appropriate motions the virtual entities should make in response to events. The simulation engine 118 can include a physics engine that can determine new poses for the virtual entities. The physics engine can have as its inputs, the skeleton models of various virtual entities, environmental settings, states such as current poses (for example, positions of body parts expressed as positions, joint angles, position of wheels, or other specifications), and velocities (linear and/or angular) of virtual objects and motions provided by a movement module, which can be in the form of a set of force/torque vectors for some or all components of the virtual entities. From this information, the physics engine generates movement, such as new poses for characters or a new position for a vehicle, using rules of physics and those new poses can be used to update virtual entity states. The simulation engine 118 provides for user input to control aspects of the game application according to defined game rules. Examples of game rules include rules for user inputs, actions/events, movement in response to inputs, and the like. Other components can control what inputs are accepted and how the game progresses, and other aspects of gameplay.

In one example, after the simulation engine 118 determines the in-game events, the in-game events can be conveyed to a movement engine that can determine the appropriate motions the virtual entity should make in response to the events and passes those motions on to a physics engine. The physics engine can determine new poses/positions for the virtual entities and provide the new poses/positions to a rendering engine.

### Rendering Engine

The rendering engine 122 can generate and render frames for output to a display within the game application. The rendering engine 122 can use simulation data, function data, and other data to generate and render frames. The rendering engine is responsible for taking the 3D scene data, including the geometry of the objects, the lighting, and the camera view, and using it to generate a 2D image that represents the scene from a specified viewpoint. The rendering engine 122 can combine the virtual objects, such as virtual characters, animate objects, inanimate objects, background objects, lighting, reflection, and the like, in order to generate a full scene and a new frame for display.

The rendering engine 122 can take into account the surfaces, colors, textures, and other parameters during the rendering process. The rendering engine 122 can combine the virtual objects (e.g., lighting within the virtual environment and virtual character images with inanimate and background objects) to generate and render a frame for display to the user. The process can be repeated for rendering each frame during execution of the game application.

During the rendering process a surface shader can be used. A surface shader is a type of shader that can determine how light interacts with the surface of an object in a 3D scene. When light hits an object, it can interact with the surface of the object and can either be absorbed, reflected, or refracted. A surface shader can be responsible for calculating the amount and type of light that is reflected off the surface of the object. It can take into account the surface's color, texture, and other physical properties, such as roughness, glossiness, and transparency. Surface shaders can be used in the rendering engine 122 to create realistic-looking objects by simulating the way light interacts with real-world materials. They can be used to create a variety of surface effects, including matte surfaces, shiny surfaces, metallic surfaces, and more.

In the rendering process, once the geometry of a 3D object has been defined, and the object has been placed in the 3D scene with appropriate lighting, the surface shader is responsible for determining how light interacts with the surface of the object. During the shading stage, the renderer uses the surface shader to calculate the color and other appearance attributes of each point on the object's surface, based on the lighting and other parameters specified in the scene. The surface shader takes into account factors such as the object's texture, reflectivity, and transparency, as well as the intensity of the light, angle of the incoming light, and the angle of the viewer's perspective.

### Game Data

The game data 114 can include game rules, prerecorded motion capture poses/paths, environmental settings, environmental objects, constraints, skeleton models, and/or other game application information. At least a portion of the game data 114 can be stored in the application data store 106. In some embodiments, a portion of the game data 114 may be received and/or stored remotely, in such embodiments, game data may be received during runtime of the game application.

### Game State Information

During runtime, the game application 110 can store game state information 116 (also referred to as game state data), which can include a game state, character states, environment states, scene object storage, and/or other information associated with a runtime state of the game application 110. For example, the game state information 116 can identify the state of the game application 110 at a specific point in time, such as a character position, character action, game level attributes, and other information contributing to a state of the game application. The game state information can include dynamic state information that is associated with the current gameplay session and can continually change with each frame, such as character actions and animations. The dynamic game state data 116 can be generated by the simulation engine 118 and passed to the rendering engine 122 during runtime to render frames. The game state information can include static state information that is updated less frequently and can be stored across multiple gameplay sessions, such as the identification of character attributes, or game progress within the game.

### Virtual Environment

As used herein, a virtual environment may comprise a simulated environment (e.g., a virtual space) instanced on a user computing system 102. The virtual environment may be instanced on a server (e.g., an application host system 132 of the interactive computing system 130) that is accessible by a client (e.g., user computing system 102) located remotely from the server, to format a view of the virtual environment for display to a user of the client. The simulated environment may have a topography, express real-time interaction by the user, and/or include one or more objects positioned within the topography that are capable of locomotion within the topography. In some implementations, the topography may be a 2-dimensional topography. In other instances, the topography may be a 3-dimensional topography. In some implementations, the topography may be a single node. The topography may include dimensions of the virtual environment, and/or surface features of a surface or objects that are “native” to the virtual environment. In some implementations, the topography may describe a surface (e.g., a ground surface) that runs through at least a substantial portion of the virtual environment. In some implementations, the topography may describe a volume with one or more bodies positioned therein (e.g., a simulation of gravity-deprived space with one or more celestial bodies positioned therein). A virtual environment may include a virtual world, but this is not necessarily the case. For example, a virtual environment may include a game space that does not include one or more of the aspects generally associated with a virtual world (e.g., gravity, a landscape, etc.). By way of illustration, the well-known game Tetris may be formed as a two-dimensional topography in which bodies (e.g., the falling tetrominoes) move in accordance with predetermined parameters (e.g., falling at a predetermined speed, and shifting horizontally and/or rotating based on user interaction).

The game instance of the game application 110 may comprise a simulated virtual environment, for example, a virtual environment that is accessible by users via user computing systems 102 that present the views of the virtual environment to a user. The virtual environment may have a topography, express ongoing real-time interaction by one or more users and/or include one or more objects positioned within the topography that are capable of locomotion within the topography. In some instances, the topography may include a two-dimensional topography. In other instances, the topography may include a three-dimensional topography. The topography may include dimensions of the space and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). In some embodiments, the instance executed by the computer components may use synchronous, asynchronous, and/or semi-synchronous architectures.

It should be understood that the above description of the virtual environment associated with the video game is not intended to be limiting. The game application may be configured to express the virtual environment in a more limited, or richer, manner. For example, views determined for the video game representing the game state of the instance of the video game may be selected from a limited set of graphics depicting an occurrence in a given place within the video game. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the video game are contemplated.

The game application 110 generates game state information 116 that may be used locally within the game application and may be transmitted to the interactive computing system 130 over network 108. The execution of the instance of the game application 110 may include determining a game state associated with the game application. The game state information may facilitate presentation of views of the video game to the users on the user computing systems 102. The game state information may include information defining the virtual environment in which the video game is played.

The execution of the game instance may enable interaction by the users with the game application and/or other users through the interactive computing system 130. The game application may be configured to perform operations in the game instance in response to commands received over network 108 from user computing systems 102. In some embodiments, users may interact with elements in the video game and/or with each other through the video game.

Users may participate in the video game through client game applications implemented on user computing systems 102 associated with the users. Within the game instance of the video game executed by the game engine, the users may participate by controlling one or more of an element in the virtual environment associated with the video game. The user-controlled elements may include avatars, user characters, virtual environment units (e.g., troops), objects (e.g., weapons, horses, vehicle and so on), simulated physical phenomena (e.g., wind, rain, earthquakes, and/or other phenomena), and/or other user-controlled elements.

The user-controlled avatars may represent the users in the virtual environment. The user characters may include heroes, knights, commanders, leaders, generals and/or any other virtual environment entities that may possess strength, skills, abilities, magic powers, knowledge, and/or any other individualized attributes. The virtual environment units controlled by the user may include troops and/or any other game entities that may be trained, recruited, captured, and/or otherwise acquired by the users in groups or en-mass. The objects controlled by the users may include weapons, vehicles, projectiles, magic items, wardrobes, boots, armor, knapsacks, medicine, healing potion, and/or any other virtual items that may be employed by the users for interaction within the video game.

The user controlled element(s) may move through and interact with the virtual environment (e.g., user-virtual environment units in the virtual environment, non-user characters in the virtual environment, other objects in the virtual environment). The user controlled elements controlled by and/or associated with a given user may be created and/or customized by the given user. The user may have an “inventory” of virtual goods and/or currency that the user can use (e.g., by manipulation of a user character or other user controlled element, and/or other items) within the virtual environment.

Controls of virtual elements in the video game may be exercised through commands input by a given user through user computing systems 102. The given user may interact with other users through communications exchanged within the virtual environment. Such communications may include one or more of textual chat, instant messages, private messages, voice communications, and/or other communications. Communications may be received and entered by the users via their respective user computing systems 102. Communications may be routed to and from the appropriate users through server(s) (e.g., through application host system 132).

Execution and/or performance of the user action by the game engine 112 may produce changes to the game state, which may reflect progresses and/or results of the user actions. In some examples, state changes caused by the execution of the user actions may be recorded in the application data store 106 to facilitate persistency throughout the instance of the video game. In some examples, execution of the user actions may not produce persistent changes to the game state (e.g., a user character jumping forward and backward successively may not produce any perceivable game state changes to other users).

A given user may input commands with specific parameters to undertake specific deeds, actions, functions, spheres of actions and/or any other types of interactions within the virtual environment. For example, the given user may input commands to construct, upgrade and/or demolish virtual buildings; harvest and/or gather virtual resources; heal virtual user-controlled elements, non-player entities and/or elements controlled by other users; train, march, transport, reinforce, reassign, recruit, and/or arrange troops; attack, manage, create, demolish and/or defend cities, realms, kingdoms, and/or any other virtual environment locations controlled by or associated with the users; craft or transport virtual items; interact with, compete against or along with non-player entities and/or virtual environment elements controlled by other users in combats; research technologies and/or skills; mine and/or prospect for virtual resources; complete missions, quests, and/or campaigns; exercise magic power and/or cast spells; and/or perform any other specific deeds, actions, functions, or sphere of actions within the virtual environment. In some examples, the given user may input commands to compete against elements in an environment within the virtual environment—e.g., Player vs. Environment (PvE) activities. In some examples, the given user may input commands to compete against each other within the virtual environment—e.g., Player vs. Player (PvP) activities.

The instance of the game application 110 may comprise virtual entities automatically controlled in the instance of the game application. Such virtual entities may or may not be associated with any user. As such, the automatically controlled virtual entities may be generated and/or developed by artificial intelligence configured with the game application and/or servers (e.g., application host system(s)) by a provider, administrator, moderator, and/or any other entities related to the game application. These automatically controlled entities may evolve within the video game free from user controls and may interact with the entities controlled by or associated with the users, other automatically controlled virtual environment entities, as well as the topography of the virtual environment. Certain manifested traits may be associated with the automatically controlled entities in accordance with the artificial intelligence configured with server(s) (e.g., application host system 132). As used herein, such automatically controlled virtual environment entities in the instance of the video game are referred to as “non-player entities.”

In an online game, the instance of the video game may be persistent. That is, the video game may continue on whether or not individual users are currently logged in and/or participating in the video game. A user that logs out of the video game and then logs back in some time later may find the virtual environment and/or the video game has been changed through the interactions of other users with the video game during the time the user was logged out. These changes may include changes to the simulated physical space, changes in the user's inventory, changes in other users' inventories, changes experienced by non-user characters, and/or other changes.

### Skin Analysis System

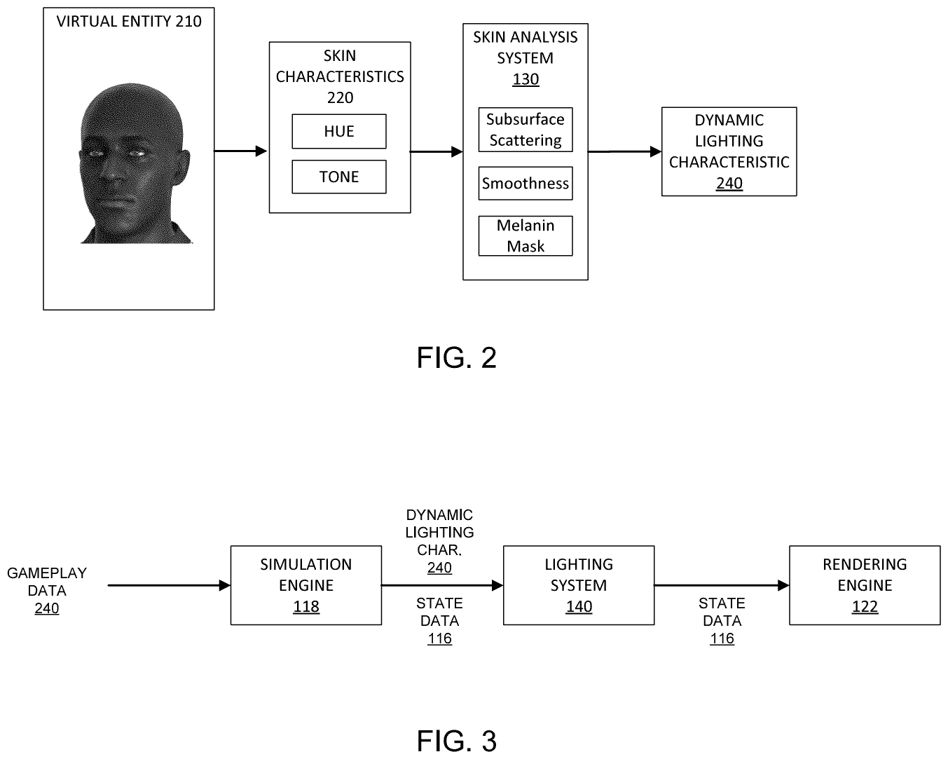

The skin analysis system is described with further reference to FIG. 2. FIG. 2 illustrates an embodiment of a data flow for generating dynamic lighting characteristic for a virtual entity 210 that can be used within a virtual environment of the game application 110 during runtime. The virtual entity 210 is an embodiment of a virtual character having a skin tone. In the illustrated example, the virtual entity is a human, however, the virtual entity can be any type of entity with skin, or skin-like surface. For example, the virtual entity may be a fictional based humanoid (e.g., troll), or non-humanoid (e.g., dragon), or other virtual entity that is rendered within a virtual environment. The entities may be controlled by a user or may be automatically controlled by the game engine 112. The color of the skin may be automatically determined by the game engine, pre-determined, or determined by a user within the game application.

The skin analysis system can analyze the skin characteristics and determine various skin characteristics and parameters. The skin analysis system can also determine a dynamic lighting characteristic associated with the virtual entity 210. The mapping of skin tone and hue to a virtual character can involve the determination of various characteristics associated with selected tone and hue of the character model. Some derived parameters can be determined by the skin analysis system, such as subsurface scattering, smoothness, melanin mask, and dynamic lighting characteristics.

### Skin Tone and Hue

The color of the skin of the virtual entity can have a plurality of selected skin tone characteristics 220. The skin characteristic can include tone and hue, which can be represented as color values, typically with RGB (Red, Green, Blue) or HSV (Hue, Saturation, Value) color models. The primary color hues that are used to generate skin tone can range from various shades of red, yellow, and brown. In game environments where the skin tones of characters can vary across fictional species, such as elves or trolls, where the skin tones can be shades of any color, such as blues, greens, and grays. In some instances, the skin can be on a gradient along a defined color scheme that can be represented by a value between two numbers, such as between zero and one.

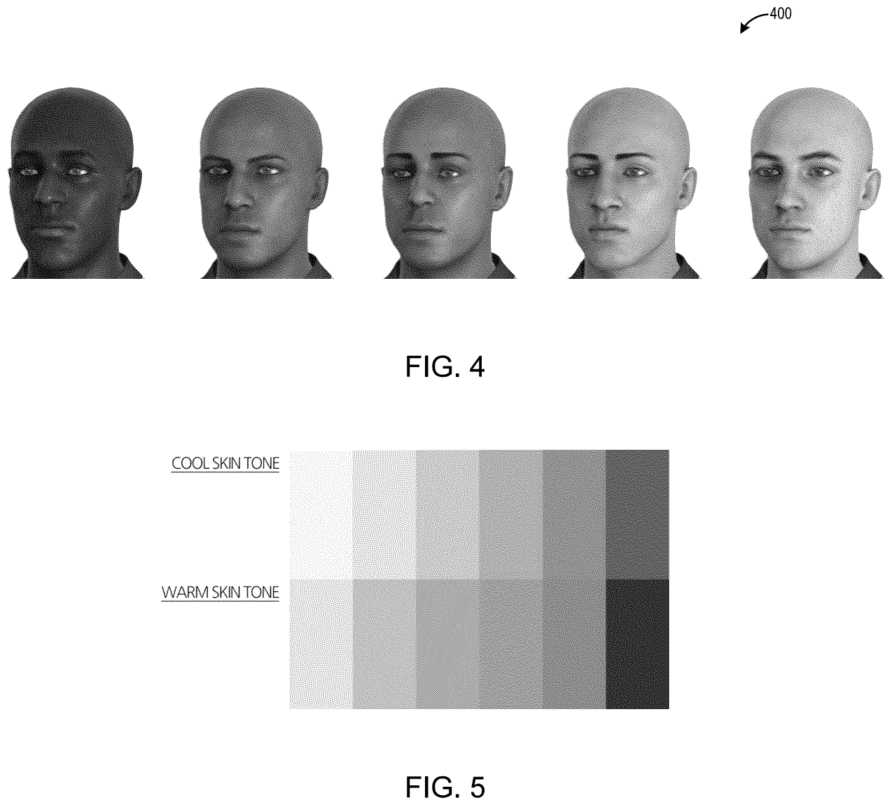

The skin tones and hues can be applied to skin textures with appropriate color variations to match different tones and hues. This is illustrated with additional reference to FIGS. 4 and 5. FIG. 4 illustrates examples of virtual characters 400 with different skin colors. FIG. 5 illustrates examples of different skin tones and different hues. Texture mapping of the skin can involve applying these textures to the 3D model's surface to simulate the complex and nuanced variations in skin tone across the character's body. A game application can provide customization options for players to adjust the skin tone and hue of their characters. This can be through a character creation menu, where players can pick from a range of predefined skin tones or even adjust a slider to achieve the desired tone and hue.

### Subsurface Scattering

Subsurface scattering can be determined based on the skin color. Subsurface scattering affects the color and behavior of light passing through and interacting with the skin. Subsurface scattering calculations use the skin's color properties to simulate light scattering within the layers of the skin, enhancing realism. Subsurface scattering can be used in skin rendering to achieve a realistic appearance, as skin is semi-translucent and scatters light within its layers. Subsurface scattering alters the color of the light as it scatters within the skin layers. For example, in human skin, longer-wavelength red light is absorbed less and penetrates deeper, contributing to the characteristic warm appearance of skin.

When light hits the surface of skin, it penetrates the outer layers and scatters within the skin due to its semi-translucent nature. Some light is absorbed by the skin, and the rest penetrates and scatters throughout the underlying layers. The scattering is determined by the material properties and the incident light direction. This scattered light eventually exits the surface, creating a soft, diffused appearance. Specialized subsurface scattering can be applied to the skin material. The subsurface scattering can calculate how light penetrates the surface, scatters within the skin, and then exits at different points. The subsurface scattering can take into account the skin's properties and simulates the scattering behavior using the chosen subsurface scattering model. Subsurface scattering varies based on the skin color of the virtual entity. The skin analysis system can determine the subsurface scattering based on the skin characteristic.

### Smoothness

The smoothness characteristic, often referred to as glossiness or shininess, is an aspect used in rendering skin to achieve a realistic appearance. It can represent how smooth or rough the surface of the skin appears, affecting how light interacts with it. Smoothness can be mapped using a texture map or a parameter that defines the level of smoothness across the skin surface. This map/parameter can control how light is reflected or scattered across different regions of the skin.

Smoothness can influence specular reflection component of the skin. A smoother surface will have a sharper, more defined specular highlight, resembling a polished or oily surface. In contrast, rougher surfaces scatter light in a broader and less intense manner, resulting in a softer highlight. Smoothness can be used to simulate the microgeometry of the skin's surface. A high smoothness value implies a smoother surface with fewer irregularities, while a lower smoothness value represents a rougher surface with more microscale imperfections. The skin analysis system can determine the smoothness parameter based on the skin characteristic of the virtual entity 210.

### Melanin Mask

A melanin mask can be used to simulate the distribution and behavior of melanin in skin. Melanin is a pigment responsible for the color of human skin, hair, and eyes. In some instances, creating a melanin mask involves generating a texture or a set of parameters that represent the distribution and intensity of melanin in various regions of the skin. The melanin mask can then be applied during the rendering process to accurately portray the color and appearance of the skin.

The melanin mask can be created using procedural texture generation techniques or manually created. The mask assigns varying levels of melanin intensity to different regions of the skin, mimicking the natural distribution found in human skin. The melanin mask can be created for any type of a virtual character and is not limited to human entities.

The melanin mask can then be used to adjust the color of the rendered skin. In areas with higher melanin intensity, the skin will appear darker, while areas with lower melanin intensity will appear lighter. By incorporating a melanin mask into the rendering process, the skin's appearance can become more realistic. It can add nuances to the skin's coloration, making it visually accurate and diverse. The melanin mask also affects how light interacts with the skin. Light absorption and scattering vary based on melanin levels, influencing the way the skin reflects and absorbs light.

The skin analysis system can determine the melanin mask based on the skin characteristic of the virtual entity 210. In some instances, the melanin mask can be a monochrome mask layered over the skin texture. The intensity of the melanin mask can be determined based on the skin color.

### Skin Tone Lighting Characteristic

The skin analysis system can generate a dynamic lighting characteristic for the virtual entity 210. The dynamic lighting characteristic can be configured to adjust dynamic light sources within the virtual environment during runtime of the game application. The virtual environment can be configured with dynamic light sources that can be adjusted prior to rendering based on the dynamic lighting characteristic. The dynamic lighting characteristic can be configured to adjust one or more parameters of the light sources. In some instances, the dynamic lighting characteristic can be configured to adjust the intensity of the light source. The dynamic lighting characteristic may be a defined gradient value between two constants (e.g., from 0 to 1). The intensity of the light source could be adjusted prior to rendering the skin of the virtual entity.

### Runtime Operation

FIG. 3 illustrates an embodiment of a runtime operation of the game engine 112 to render virtual objects using dynamic lighting within the virtual environment. During runtime, the simulation engine 118 receives gameplay data 240 generated during runtime. The simulation engine 118 can output state data 116 associated with virtual entities 210 and can pass the dynamic lighting characteristic to the lighting system 120 prior to rendering. The state data 116 can be generated by the simulation engine 118 and can include instructions defining the game state for rendering. Generally, the lighting system 120 does not adjust the lights based on skin characteristic. Rather, the rendering engine determines how the lighting interacts with the material properties of virtual objects. In the present system, the dynamic lighting characteristic for a virtual character is being passed to the lighting system 120, in order to adjust the lighting prior to rendering.

The lighting system 140 controls light sources during runtime of the game application. The lighting system receives the state data 116 from the simulation engine to control light sources that are present within a game scene. The lighting system can control the output of each light source within the scene, such as point lights, directional lights, spotlights, and ambient lights. Each light source contributes to the illumination of the object's surface. The contribution of each light source can be used by the rendering engine to determine how the scene is rendered. The lighting system 140 can receive the dynamic lighting characteristic and adjust one or more parameters of light source(s) within the game scene. Light sources can be configurable such that they can be modified by the dynamic lighting characteristic.

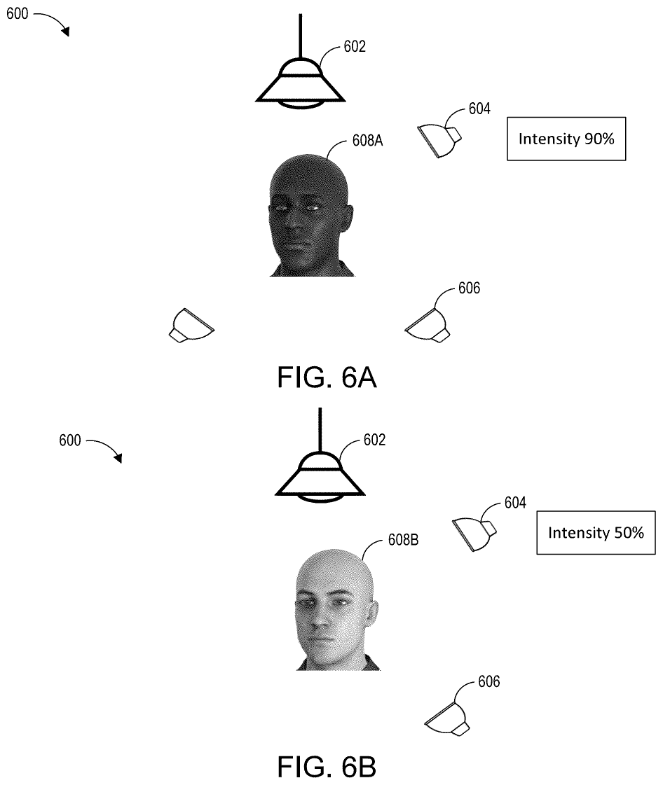

Lighting a game scene is described with additional reference to FIGS. 6A and 6B, which illustrate a plurality of light sources within a game scene 600. In FIG. 6A the virtual character 608A has a darker skin tone and in FIG. 6B the virtual character 608B has a lighter skin tone. In FIGS. 6A and 6B, the game scene 600 includes an ambient light source 602, a dynamic light source 604, and a secondary light source 606. The ambient light source 602 and secondary light source 606 are standard light sources that provide a defined amount of illumination regardless of the virtual character 608A or 608B within the game scene. The dynamic light source 604 can be configured so that one or more parameter of the light source are adjusted based on a dynamic lighting characteristic of the virtual entity being rendered. In the illustrated example, the intensity of the light source is being adjusted based on the dynamic lighting characteristic associated with virtual characters 608A or 608B. The adjustment to the parameter of the dynamic light source can be a relative adjustment. In this manner, the relative lighting levels within a game scene can be sufficiently maintained. Any number and/or type of light source may be a dynamic light source that is configured to be adjusted dynamically based on the dynamic lighting characteristic associated with a virtual entity.

In instances where multiple virtual characters are present in the same scene, the characters may have defined priority levels, such that the dynamic light sources only use the dynamic lighting characteristic associated with the virtual character with the highest priority level. For example, the player character may generally have a higher priority level than non-player characters. In some instances, the priority levels of virtual characters may be changed to account for a different game scene. For example, a non-player character may be the focal point of the game scene. In another instance, a specific game scene may have insufficient lighting for a darker skinned character, and priority levels may shift based on the skin tone of characters within the game scene.

After the lighting system adjusts the appropriate lights based on the dynamic lighting characteristic, the state data, including the adjusted light source data is provided to the rendering engine to render the scene. The rendering engine is responsible for taking the scene data, which may be 3D, including the geometry of the objects, the lighting, and the camera view, and using it to generate a 2D image that represents the scene from a specified viewpoint. As part of this process, the rendering engine uses the surface shader to determine the appearance of each point on the surface of the objects in the scene, taking into account the lighting, textures, and other properties that have been assigned to the objects.

A surface shader is a type of shader that determines how light interacts with the surface of an object in a 3D scene. When light hits an object, it interacts with the surface of the object and is either absorbed, reflected, or refracted. A surface shader is responsible for calculating the amount and type of light that is reflected off the surface of the object. It takes into account the surface's color, texture, and other physical properties, such as roughness, smoothness, subsurface scattering, melanin concentration, and transparency. Surface shaders are commonly used in 3D graphics applications to create realistic-looking objects by simulating the way light interacts with real-world materials.

When rendering a game scene, a surface shader can be used to calculate how light interacts with the surfaces of the virtual entities/objects within the scene. The surface shader can utilize lighting equations and/or models, which can calculate the total light reaching a point on the surface. This can include contributions from ambient, diffuse, and specular lighting components, each determined by the material properties and the angle between the light and the surface. The surface shader can combine the contributions from ambient, diffuse, and specular components based on their respective weights and adds them to determine the final color or intensity of the surface at a particular point. The surface shader repeats these calculations for each point on the object's surface to compute the lighting across the entire object, resulting in a rendered frame with appropriate lighting effects. In short, the surface shader can take into account the parameters of the lights, such as light intensity, and skin characteristic, such as the smoothness, subsurface scattering, and melanin mask, to determine how to render a game scene. The rendering engine 122 can then render an image for the game scene. This process occurs multiple times per second during runtime. For example, the rendering system can render frames at a frame rate of 30, 60, or any number of frames per second.

### Skin Tone Analysis Process

FIG. 7 illustrates an embodiment of a flowchart for a process for execution of a skin tone analysis process 700 during runtime of a game application. The process 700 can be implemented by any system that can analyze and generate visual within a game environment during runtime of a game application. For example, the process 700, in whole or in part, can be implemented by a game application 110, a game engine 112, a simulation engine 118, a lighting system 140, a surface shader, a rendering engine 122, or other application modules. Although any number of systems, in whole or in part, can implement the process 700, to simplify discussion, the process 700 will be described with respect to the computing system 102.

At block 702, the game application can receive skin coloring of a virtual entity. The skin coloring of the virtual entity can include skin characteristic, such as tone and hue. The skin characteristic are generated for a virtual entity, such as a virtual character. The virtual entity has a defined skin coloring. The skin coloring of the virtual entity may be selected by a user when creating a character within a game. The skin coloring selection may be performed by the game application, such as pregenerated during development of the game application, generated during runtime, and/or by another process that defines the skin coloring of the virtual entity. The skin characteristic for the skin coloring can include the hue and tone. After the selection of the skin coloring, which includes tone and hue, the game engine can determine parameters associated with the skin coloring.

At block 704, the game application can determine a smoothness characteristic associated with virtual entity. The smoothness characteristic can be determined based on the skin characteristic of the virtual entity. In some instances, darker skin colorings can have generally higher smoothness than lighter skin colorings. The smoothness characteristic can be automatically calculated based on the skin characteristic.

At block 706, the game application can determine subsurface scattering based on the skin coloring of the virtual entity. Subsurface scattering can be determined based on the skin color. subsurface scattering affects the color and behavior of light passing through and interacting with the skin. Subsurface scattering calculations use the skin's color properties to simulate light scattering within the layers of the skin, enhancing realism. The subsurface scattering can calculate how light penetrates the surface, scatters within the skin, and then exits at different points. The subsurface scattering can use the skin's properties and simulates the scattering behavior using the chosen subsurface scattering model. Subsurface scattering varies based on the skin color of the virtual entity. The skin analysis system can determine the subsurface scattering based on the skin characteristic.

At block 708, the game application can determine a melanin mask based on the skin coloring of the virtual entity. A melanin mask can be used to simulate the distribution and behavior of melanin in skin. Melanin is a pigment responsible for the color of human skin, hair, and eyes. In some instances, creating a melanin mask involves generating a texture or a set of parameters that represent the distribution and intensity of melanin in various regions of the skin. The melanin mask can then be applied to more accurately portray the color and appearance of the skin. The skin analysis system can determine the melanin mask based on the skin characteristic of the virtual entity 210. In some instances, the melanin mask can be a monochrome mask layered over the skin texture. The intensity of the melanin mask can be determined based on the skin color.

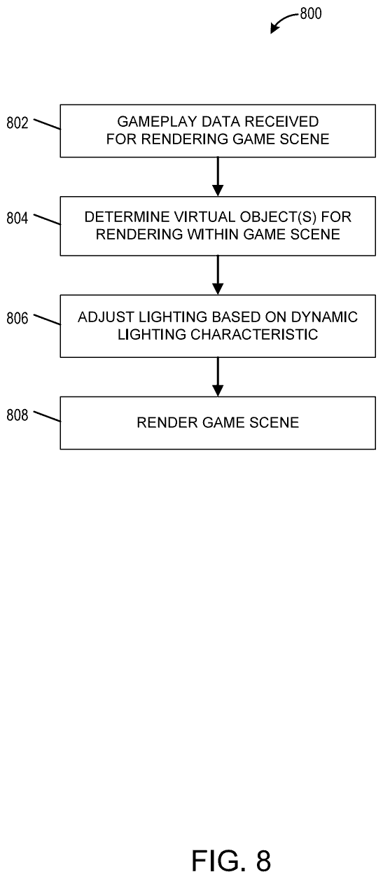

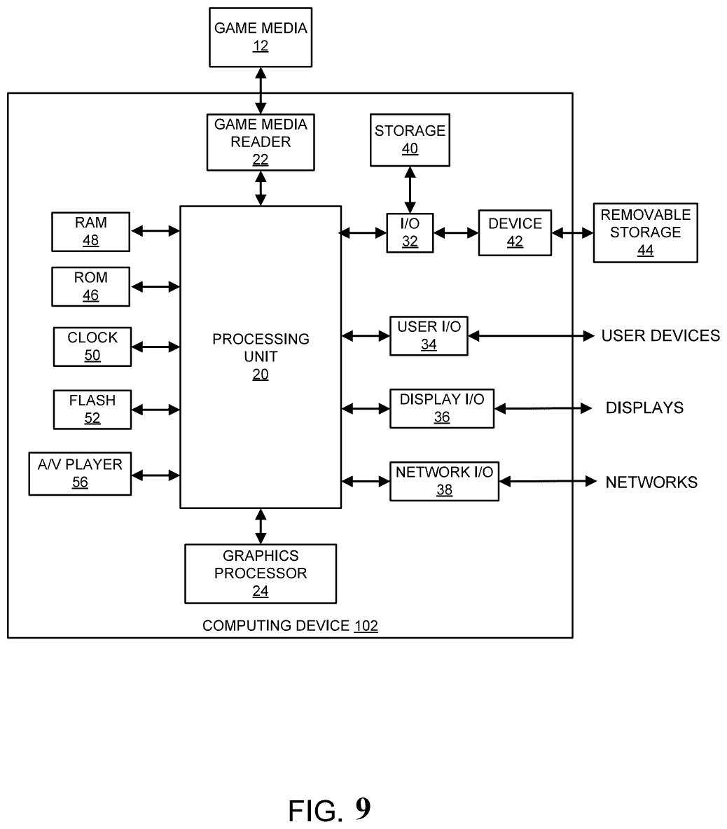

At block 710, the game application can determine a dynamic lighting characteristic based on the skin coloring of the virtual entity. The dynamic lighting characteristic can be configured to adjust dynamic light sources within the virtual environment during runtime of the game application. The virtual environment can be configured with dynamic light sources that can be adjusted prior to rendering based on the dynamic lighting characteristic. The dynamic lighting characteristic can be configured to adjust one or more parameters of the light sources. In some instances, the dynamic lighting characteristic can be configured to adjust the intensity of the light source. The dynamic lighting characteristic may be a defined gradient value between two constants (e.g., from 0 to 1). The intensity of the light source could be adjusted prior to rendering the skin of the virtual entity. Rendering during runtime using the dynamic lighting characteristic is discussed in further detail within reference to the method 800 in FIG. 8.

### Visual Content Rendering

FIG. 8 illustrates an embodiment of a flowchart for a process for execution of a process for visual content rendering using dynamic lighting 800 during runtime of a game application. The process 800 can be implemented by any system that can analyze and generate visual within a game environment during runtime of a game application. For example, the process 700, in whole or in part, can be implemented by a game application 110, a game engine 112, a simulation engine 118, a lighting system 140, a surface shader, a rendering engine 122, or other application modules. Although any number of systems, in whole or in part, can implement the process 800, to simplify discussion, the process 800 will be described with respect to the computing system 102.

At block 802, gameplay data is received by the game engine for rendering. The gameplay information may include information such as location of the virtual entity within the virtual game environment, movement associated with the virtual entity, light sources, characters in the scene, and other factors that can determine the information necessary to render the virtual entities within the virtual environment. The game engine receive updated gameplay information multiple times per second in order to render frames. For example, the game engine may render frames at 30, 60, or more frames per second.

At block 804, the game engine identifies virtual entities within a game scene for rendering based on the gameplay data. The game engine can determine a dynamic lighting characteristic associated with the virtual entities. In some embodiments, the game engine can identify priorities associated with the virtual entities. The game engine can determine lighting for the scene and the light sources that are associated with each virtual entity. The game engine can control the output of each light source within the scene, such as point lights, directional lights, spotlights, and ambient lights. Each light source can contribute to the illumination of virtual entity's surface. The game scene can include light sources that are specific to a character. For example, each character may have specific light source(s) that are used for rendering the character. The game engine can identify dynamic light source(s) that are configured to be adjusted based on the dynamic lighting characteristic of a virtual entity.

At block 806, the game engine can adjust the lighting based on the dynamic lighting characteristic of a virtual entity. One or more parameters of the light source can be adjusted based on the dynamic lighting characteristic of the entity. The relative intensity level for the light source can be adjusted based on the dynamic lighting characteristic. For example, the intensity of the light source may be increased for darker skin tones and reduced for lighter skin tones. In some embodiments, it is possible to have more than one character within a game scene where the dynamic lighting characteristic is being utilized to individually render the different virtual characters within the scene. For example, two characters having different skin coloring may each have their individual dynamic lighting characteristic, which can be used to adjust the parameters of dynamic light sources that are specific to the virtual character. For situations where there is a general light source that globally affects characters within a scene, the characters may be prioritized based on relative importance within a scene. In such a case, the dynamic lighting characteristic of the virtual character with the highest priority character can be utilized to control the parameters of dynamic light source(s) within the game scene.

At block 808, the game engine can render virtual entity within game scene based on rendering parameters. The game engine can use the rendering parameters, such as the lighting, surfaces, colors, and textures, to generate a frame for the game scene. The game engine can use the parameters of the lights, such as light intensity, and skin characteristic, such as the smoothness, subsurface scattering, and melanin mask, to determine how to render a game scene. The game engine can combine the virtual objects to generate and render a frame for display to the user.

### Overview of Computing Device

FIG. 7 illustrates an embodiment of computing device 10 according to the present disclosure. Other variations of the computing device 10 may be substituted for the examples explicitly presented herein, such as removing or adding components to the computing device 100. The computing device 10 may include a game device, a smart phone, a tablet, a personal computer, a laptop, a smart television, a car console display, a server, and the like. As shown, the computing device 10 includes a processing unit 20 that interacts with other components of the computing device 10 and also external components to computing device 10. A media reader 22 is included that communicates with media 12. The media reader 22 may be an optical disc reader capable of reading optical discs, such as CD-ROM or DVDs, or any other type of reader that can receive and read data from game media 12. One or more of the computing devices may be used to implement one or more of the systems disclosed herein.

Computing device 10 may include a separate graphics processor 24. In some cases, the graphics processor 24 may be built into the processing unit 20. In some such cases, the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a handheld video game device, a dedicated game console computing system, a general-purpose laptop or desktop computer, a smart phone, a tablet, a car console, or other suitable system.

Computing device 10 also includes various components for enabling input/output, such as an I/O 32, a user I/O 34, a display I/O 36, and a network I/O 38. I/O 32 interacts with storage element 40 and, through a device 42, removable storage media 44 in order to provide storage for computing device 10. Processing unit 20 can communicate through I/O 32 to store data, such as game state data and any shared data files. In addition to storage 40 and removable storage media 44, computing device 10 is also shown including ROM (Read-Only Memory) 46 and RAM 48. RAM 48 may be used for data that is accessed frequently, such as when a game is being played or the fraud detection is performed.

User I/O 34 is used to send and receive commands between processing unit 20 and user devices, such as game controllers. In some embodiments, the user I/O can include a touchscreen inputs. The touchscreen can be capacitive touchscreen, a resistive touchscreen, or other type of touchscreen technology that is configured to receive user input through tactile inputs from the user. Display I/O 36 provides input/output functions that are used to display images from the game being played. Network I/O 38 is used for input/output functions for a network. Network I/O 38 may be used during execution of a game, such as when a game is being played online or being accessed online and/or application of fraud detection, and/or generation of a fraud detection model.

Display output signals produced by display I/O 36 comprising signals for displaying visual content produced by computing device 10 on a display device, such as graphics, user interfaces, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such a display 16.

The computing device 10 can also include other features that may be used with a game, such as a clock 50, flash memory 52, and other components. An audio/video player 56 might also be used to play a video sequence, such as a movie. It should be understood that other components may be provided in computing device 10 and that a person skilled in the art will appreciate other variations of computing device 10.

Program code can be stored in ROM 46, RAM 48 or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as game media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other game and processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from game media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method for generating visual content within a game application, comprising:
by a hardware processor configured with computer executable instructions,
executing a game application comprising a virtual environment, the virtual environment comprising a plurality of virtual entities;
determining simulation data associated with runtime of the game application based at least in part on gameplay information associated with a gameplay state of the game application;
identifying a first virtual entity based at least in part on the simulation data within a game scene, wherein the first virtual entity is associated with a first dynamic lighting characteristic;
identifying a first dynamic light source associated with the game scene;
modifying at least one parameter of the first dynamic light source based at least in part on the first dynamic lighting characteristic, wherein the modification of the at least one parameter changes light incident on the first virtual entity within the game scene; and
rendering the at least one virtual entity within the game scene based at least in part on the first dynamic light source.

2. The computer-implemented method of claim 1, wherein the at least one parameter of the dynamic light source is a light intensity.

3. The computer-implemented method of claim 1, wherein the game scene includes a second virtual entity is associated with a second dynamic lighting characteristic.

4. The computer-implemented method of claim 3, wherein the first virtual entity is associated with a first priority value and the second virtual entity is associated with a first priority value, wherein the method comprises determining that the first priority value is greater than the second priority value and modifying the at least one parameter of the first dynamic light source based on the first dynamic lighting characteristic.

5. The computer-implemented method of claim 3, further comprising modifying at least one parameter of a second dynamic light source based at least in part on the second dynamic lighting characteristic.

6. The computer-implemented method of claim 1, wherein the first dynamic light source is one of a plurality of light sources within the game scene and at least one light source of the plurality of light sources is not modified by the first dynamic lighting characteristic.

7. The computer-implemented method of claim 1, wherein the first dynamic characteristic is determined based on a skin coloring of a skin texture of the first virtual entity.

8. The computer-implemented method of claim 7, wherein rendering the at least one virtual entity within the game scene is based at least in part on the light incident on the skin texture of the first virtual entity within the game scene.

9. The computer-implemented method of claim 7, wherein rendering the at least one virtual entity within the game scene is based at least in part on a smoothness characteristic, subsurface scattering, and a melanin mask associated with the skin texture of the first virtual entity, wherein the smoothness characteristic, the subsurface scattering, and the melanin mask are determined based on the skin coloring of the first virtual entity.

10. Non-transitory computer-readable medium storing computer-executable instructions that when executed by one or more processors, cause the one or more processors to perform operations comprising, comprising:
executing a game application comprising a virtual environment, the virtual environment comprising a plurality of virtual entities;
determining simulation data associated with runtime of the game application based at least in part on gameplay information associated with a gameplay state of the game application;
identifying a first virtual entity based at least in part on the simulation data within a game scene, wherein the first virtual entity is associated with a first dynamic lighting characteristic;
identifying a first dynamic light source associated with the game scene;
modifying at least one parameter of the first dynamic light source based at least in part on the first dynamic lighting characteristic, wherein the modification of the at least one parameter changes light incident on the first virtual entity within the game scene; and
rendering the at least one virtual entity within the game scene based at least in part on the first dynamic light source.

11. The non-transitory computer-readable medium of claim 10, wherein the at least one parameter of the dynamic light source is a light intensity.

12. The non-transitory computer-readable medium of claim 10, wherein the game scene includes a second virtual entity is associated with a second dynamic lighting characteristic.

13. The non-transitory computer-readable medium of claim 12, wherein the first virtual entity is associated with a first priority value and the second virtual entity is associated with a first priority value, wherein the instructions further configure the one or more processors to perform operations comprising determining that the first priority value is greater than the second priority value and modifying the at least one parameter of the first dynamic light source based on the first dynamic lighting characteristic.

14. The non-transitory computer-readable medium of claim 13, wherein the instructions further configure the one or more processors to perform operations comprising modifying at least one parameter of a second dynamic light source based at least in part on the second dynamic lighting characteristic.

15. The non-transitory computer-readable medium of claim 10, wherein the first dynamic light source is one of a plurality of light sources within the game scene and at least one light source of the plurality of light sources is not modified by the first dynamic lighting characteristic.

16. The non-transitory computer-readable medium of claim 10, wherein the first dynamic characteristic is determined based on a skin coloring of a skin texture of the first virtual entity.

17. The non-transitory computer-readable medium of claim 16, wherein rendering the at least one virtual entity within the game scene is based at least in part on the light incident on the skin texture of the first virtual entity within the game scene.

18. The non-transitory computer-readable medium of claim 17, wherein rendering the at least one virtual entity within the game scene is based at least in part on a smoothness characteristic, subsurface scattering, and a melanin mask associated with the skin texture of the first virtual entity, wherein the smoothness characteristic, the subsurface scattering, and the melanin mask are determined based on the skin coloring of the first virtual entity.

19. A system comprising one or more processors and non-transitory computer storage medium storing instructions that when executed by the one or more processors, cause the one or more processors to perform operations comprising:
executing a game application comprising a virtual environment, the virtual environment comprising a plurality of virtual entities;
determining simulation data associated with runtime of the game application based at least in part on gameplay information associated with a gameplay state of the game application;
identifying a first virtual entity based at least in part on the simulation data within a game scene, wherein the first virtual entity is associated with a first dynamic lighting characteristic;
identifying a first dynamic light source associated with the game scene;
modifying at least one parameter of the first dynamic light source based at least in part on the first dynamic lighting characteristic, wherein the modification of the at least one parameter changes light incident on the first virtual entity within the game scene; and
rendering the at least one virtual entity within the game scene based at least in part on the first dynamic light source.

20. The system of claim 19, wherein the first dynamic light source is one of a plurality of light sources within the game scene and at least one light source of the plurality of light sources is not modified by the first dynamic lighting characteristic.
